(19) United States
(12) Patent Application Publication
(10) Pub. No.: US 2011/0064850 A1
(43) Pub. Date: Mar. 17, 2011

(54) METHOD OF PRODUCING FERMENTED TEA DRINK

(76) Inventor: Masumi Takemoto, Shizouka (JP)

(21) Appl. No.: 12/934,744

(22) PCT Filed: Mar. 27, 2009
(86) PCT No.: PCT/JP2009/001394

§ 371 Date: Nov. 23, 2010

(30) Foreign Application Priority Data
Mar. 28, 2008 (JP) 2008-087504

(51) Int. Cl. A23F 3/20; A23F 3/08

(52) U.S. Cl. 426/49; 426/597

(57) ABSTRACT

Disclosed is a process for preparing a fermented tea drink comprising the steps of: adding water to fresh tea leaves and milling the mixture; removing a solid fraction from the mixture; and heating the liquid, or adding water to fresh tea leaves and milling the mixture; incubating the mixture with shaking for 1 to 40 minutes; removing a solid fraction from the mixture; and heating the liquid; to obtain the fermented tea drink. Catechins can be efficiently converted into theaflavin to provide a fermented tea drink that has a high content of theaflavin, theasinensins A and B, and gallic acid, that exhibits little bitterness and astringency, that is entirely free of cream down, and that has an excellent aroma and sweetness.

### RELATED APPLICATION

This application claims priority based on Japanese Patent Application No. 2008-87504 filed 28 Mar. 2008, the contents of which are hereby incorporated by reference.

### TECHNICAL FIELD

The present invention relates to a process for preparing a fermented tea drink.

### BACKGROUND ART

Primarily four catechins (epicatechin (EC), epigallocatechin (EGC), epicatechin gallate (ECG), and epigallocatechin gallate (EGCG)) are present in tea leaves, and four theaflavins (theaflavin (TF), theaflavin-3-O-gallate (TF3-G), theaflavin-3′-O-gallate (TF3′-G), and theaflavin-3,3′-di-O-gallate (TFDG)) are produced by the catechin combinations indicated below during the process of producing black tea, i.e., during the fermentation process.

EC+EGC→TF

EC+EGCG→TF3-G

ECG+EGC→TF3′-G

ECG+EGCG→TFDG

The following methods are generally used to obtain fermented tea: methods in which the tea leaves are fermented in slurry form; methods in which the tea leaves are ground, a small quantity of water is added, and stirring with shaking is performed. In these methods, the four catechins cited above undergo oxidative polymerization under the effect of the polyphenol oxidase present in the tea leaves, resulting in the production of theaflavin and three types of theaflavin gallate. However, these methods have various drawbacks such as bitterness and astringency, cream down, and a dark red color occur due to the residual EGCG and ECG.

The presence of gallate group contributes in generation of a bitter and astringent taste in fermented tea drinks. For example, the ECG and EGCG in green tea are strongly bitter and astringent, while the EC and EGC are lightly bitter. A bitter and astringent taste is produced when green tea catechins remain present in black tea. In addition, with regard to black tea, the presence of EGCG, ECG, TF3G, TF3′G, and TFDG in black tea causes cream-down. EGCG and ECG have a particularly prominent influence on cream-down. In order to solve these problems, a method has been developed where the bitter and astringent taste is reduced through cleavage of the gallate group in EGCG, ECG, TF3G, TF3′G, and TFDG by the addition of tannase during the fermentation step (see, for example, Japanese Patent Application Laid-open No. H11-225672). Another method involves addition of a solution of enzymes such as cellulase, hemicellulase, and protopectinase that disrupt tea leaf tissue in the fermentation process of fresh tea leaves (see, for example, Japanese Patent Application Laid-open No. 2004-113090).

The reference documents cited in the application are as indicated below. The contents of these documents are hereby incorporated by reference in its entirety.

Patent Reference 1: Japanese Patent Application Laid-open No. H11-225672

### Patent Reference 2: Japanese Patent Application Laid-open No. 2004-113090

### DISCLOSURE OF THE INVENTION

An object of the present invention is to provide a process for preparing a fermented tea drink that is rich in theaflavin, theaflavin-3-O-gallate, theaflavin-3′-O-gallate, and theaflavin-3,3′-di-O-gallate, that contains almost none of the bitter/astringent components epigallocatechin gallate, epicatechin gallate, epigallocatechin, and epicatechin, wherein the tea drink exhibits little bitterness and astringency, is free of cream-down, and has an excellent aroma and sweetness, as well as to provide a process for preparing a fermented tea concentrated solution and a powdered fermented tea concentrate.

The inventor discovered that a black tea-flavored fermented tea drink that substantially free of epigallocatechin gallate and epicatechin gallate, that exhibits little bitterness and astringency, that exhibits an excellent sweetness and aroma, and that is entirely free of cream down can be obtained by adding a large amount of water to fresh, unwithered tea leaves and milling with a mixer, removing a solid fraction therefrom and heating, or by adding a large amount of water to fresh tea leaves and milling, shaking for a short period of time, and removing a solid fraction therefrom and heating. That is, the present invention provides a process for preparing a fermented tea drink, comprising the steps of: adding water to fresh tea leaves and milling for 1 second to 40 minutes, preferably 5 to 20 minutes, removing a solid fraction from the mixture, and heating the liquid, or the steps of adding water to fresh tea leaves and milling with a mixer for 1 second to 20 minutes, preferably 3 to 5 minutes, shaking the mixture for 1 to 60 minutes, preferably 3 to 40 minutes, removing a solid fraction from the mixture, and heating the liquid. As used herein, “substantially free of epigallocatechin gallate and epicatechin gallate” means that the total quantity of epigallocatechin gallate and epicatechin gallate in the product is less than 0.1% with reference to the weight of the starting fresh tea leaves, and also means that peaks for these substances are not observed in ordinary high-performance liquid chromatographic (HPLC) analysis, such as that used in the examples provided herebelow. In addition, incubation is preferably carried out with the addition of at least five-fold water (w/w; on a weight basis with respect to the fresh tea leaves), and more preferably with the addition of at least seven-fold water (w/w). According to the present invention, a fermented tea drink can be obtained by efficiently converting all of the catechins to theaflavin-3-O-gallate, theaflavin-3′-O-gallate, theaflavin-3,3′-di-O-gallate, and theaflavin as the main component, without the exogenous addition of enzymes such as tannase or tea leaf tissue disrupting enzymes.

According to the process of the present invention, the four catechins (EC, EGC, ECG, EGCG) in tea leaves that will cause a bitter and astringent taste are almost entirely converted to catechine polymers including theaflavin, theaflavin-3-O-gallate, theaflavin-3′-O-gallate, and theaflavin-3,3′-di-O-gallate and theasinensins A and B. As a consequence, the fermented tea drink produced according to the present invention has a bright orange color and an enhanced sweetness and aroma, and exhibits a mild flavor with almost no bitterness and astringency because it is almost entirely free of the epigallocatechin gallate, epicatechin gallate, epigallocatechin, and epicatechin that are bitterness and astringency components. In addition, the fermented tea drink thus obtained exhibits an excellent storage stability. With reference to the four theaflavins, the fermented tea drink of the present invention has a particularly high TF content and a low content of TF3G, TF3′G, and TFDG, and is free of EGCG and ECG which may cause creaming, and thus the fermented tea drink of the present invention does not undergo cream-down. Tannase is frequently added to conventional fermented tea drinks in order to prevent creaming. In contrast, a fermented tea drink completely free of the creaming phenomenon can be produced according to the present invention through the combined reactions of the various enzymes present in the fresh tea leaves. In experiments at the cellular level, theaflavin has been reported to have much higher platelet aggregation inhibitory activity than EGCG and a higher activity than TF3G, TF3′G, and TFDG. Moreover, a high antioxidation activity, a high antibacterial activity, and a high blood sugar lowering activity have also been reported. However, the theaflavin content in conventional black tea leaves is as low as 0.08%. The theaflavin content in the fermented tea drink produced according to the present invention is much higher than conventional tea drinks. Thus, the fermented tea drink of the present invention is expected to serve as a health drink for the prevention of lifestyle diseases, for example, in individuals with a risk of thrombosis or high blood sugar level.

### PREFERRED EMBODIMENT OF THE INVENTION

The fresh tea leaves used in the process of the present invention refer to tea leaves after harvested but prior to execution of the withering step, and also refer to tea leaves frozen after harvesting but prior to the execution of the withering step. The fresh tea leaves encompass both fresh tea leaves and stems, which may be used separately or in combination. The starting fresh tea leaves may be tea leaves of any of the green tea and black tea cultivars in general cultivation. Examples of typical tea leaves in cultivation in Japan include asatsuyu, yabukita, yamatomidori, makinoharawase, kanayamidori, okumidori, ooiwase, okuhikari, meiryoku, samidori, komakage, yamanami, minekaori, hatsumomiji, benifuuki, benihomare, and benihikari. The present invention is not limited to these cultivars, and tea leaves from any cultivar grown domestically or overseas can also be used. The fresh tea leaves may be used immediately after harvest or may be frozen immediately after harvest and stored before use. The tea leaf harvest time can be first flush, second flush, third flush, or fourth flush. The catechin quantities and the activities of the polyphenol oxidase, peroxidase, tannase, and hydrolytic enzymes vary with harvest, and the process conditions are preferably controlled as appropriate depending on the particular quality of tea leaf used. When the cost, catechin quantity, enzymatic activity, and so forth are comprehensively evaluated, second flush teas are desirable for the tea leaf used in the process of the present invention. In the case of fourth flush teas, the catechin quantity and enzymatic activity are fairly inferior, but the enzymes may be activated when the tea leaves are held for several days at room temperature after harvesting, thus yielding a fermented tea with an excellent taste and aroma. In addition, after the tea leaves are incubated with shaking, an antioxidant (for example, ascorbic acid, sodium ascorbate, or a fruit juice such as lemon juice) may be added to the shaken liquid in order to prevent oxidation of the theaflavins.

In the process of the present invention, first, water is added to the fresh tea leaves prior to the withering step and the fresh tea leaves are milled in water using, for example, a mixer. Preferably the milling step is carried out after the water is added to the tea leaves. If the water is added after the tea leaves have been milled in air, the components present in the cells of the tea leaves will not transfer well into the aqueous phase and the fermentation may not develop adequately. The milling step can be carried out at a temperature from 0° C. to 30° C. After milling, the mixture is incubated with shaking without separating the water from the tea leaves. When water is added to the fresh tea leaves and milled, components present in the cells of the tea leaves, e.g., polyphenol oxidase, peroxidase, tannase, hydrolytic enzymes, and various tea components such as catechins and caffeine will leach into the water. When the liquid containing these enzymes and components have leached is subjected to shake incubation, the catechins are converted into theaflavins by the action of these enzymes.

Peroxidase is an enzyme that produces theaflavin in the presence of hydrogen peroxide. In the process of the present invention, hydrogen peroxide need not to be added because it is produced metabolically. Polyphenol oxidase is an enzyme that produces theaflavins in the presence of oxygen. Tannase can cleave off the gallate group of catechins and theaflavins. Cleavage of the gallate group also occurs by the action of the hydrolytic enzymes. Gallic acid is produced by these reactions. In addition, theasinensin A is produced by the dehydrogenation and condensation of two EGCGs through their pyrogallol rings, while theasinensin B is produced by dehydrogenation and condensation between EGCG and EGC through their pyrogallol rings.

In the process of the present invention, shaking step is carried out for a short period of time after the addition of water to the fresh tea leaves and milling without a solid/liquid separation. When a large quantity of water is added to the fresh, unwithered tea leaves, milled with a mixer for 1 second to 5 minutes, and incubated with shaking for 1 to 40 minutes, most of the four catechins present in the fresh tea leaves is converted to theaflavins. In addition, when water is added to the fresh tea leaves and milled with a mixer for 1 second to 40 minutes, preferably 5 to 20 minutes, most of the four catechins present in the fresh tea leaves are converted to theaflavins. The mixer used herein is a household mixer (blender) with a capacity of approximately 700 to 1000 mL and an output power of about 200 to 300 W. When the process of the present invention is scaled up to the industrial production level, those skilled in the art can select a suitable milling time in view of the device used and the quantity to be processed. An example of an industrial production mixer that can be used in the process of the present invention is a commercial mixer (blender) with a capacity of approximately 4000 mL and an output power of about 1400 W, with the revolving speed of high speed (18,500 rpm), medium speed (16,300 rpm), or low speed (14,000 rpm). A custom-made blender may be used when even greater scale is desired, or the mixing process may be repeated in conformity to the quantity of tea leaves. Any device capable of milling can be used to mill the fresh tea leaves, and examples include mixers, ultramizers, hammer mills, homogenizers, and so forth, where mixers (blenders) are particularly preferred.

The shaking time will vary depending on the type of tea leaf used, the water content, the storage conditions, and so forth, but is preferably from 1 minute to 40 minutes, more preferably from 5 minutes to 30 minutes, and even more preferably from 3 minutes to 20 minutes. When shaking is continued for a long period of time, for example, for 1 hour or more, the generated theaflavins undergo oxidation or polymerization. As a consequence the content of the theaflavins in the fermented tea undergoes a sharp decline, the fermented tea has a weak aroma, and a perception of bitterness will occur. The optimal shaking time will vary with the tea leaf used, and those skilled in the art can easily optimize the conditions. The shaking temperature should be within the temperature range in which the enzymes can function, but is not otherwise particularly limited, and is, for example, from 10° C. to 40° C. and preferably from 20° C. to 30° C.

The quantity of water added to the fresh tea leaves can be selected as appropriate depending on the type of tea leaves used, the water content, the storage conditions, and so forth, but is preferably from 5 mL to 500 mL per 1 g fresh tea leaves, more preferably from 7 mL to 200 mL per 1 g fresh tea leaves, and even more preferably from 10 mL to 100 mL per 1 g fresh tea leaves. At less than 5 mL, the quantity of theaflavins production will decline, while at more than 500 mL the resulting fermented tea will have little flavor. In addition, a green tea extract may be used in addition to the water or in place of the water. An aqueous solution that contains four catechins can be used as the green tea extract, for example, a liquid prepared by the addition of water to heat-processed green tea leaves and extraction; a liquid prepared by the addition of water to heat-processed green tea leaves, extraction, concentration to give a tea extract, and addition of water to the tea extract; and a liquid prepared by the addition of water to a tea extract.

After milling the tea leaves with a mixer for a desired period of time followed by shake incubation or after milling the tea leaves with a mixer for a desired period of time, the reaction mixture is filtered to remove the solid fraction from liquid. The filtration step may be carried out by gravity filtration or by suction filtration under reduced pressure. Alternatively, the solid fraction may be removed by centrifugation. If the filtrate is cloudy and does not become transparent after filtration or centrifugation, the filtrate may be left stand for about a day and then processed by gravity filtration, suction filtration under reduced pressure, or centrifugation. The resulting solution will have an orange or bright red color. The liquid is bottled and heated at from 95° C. to 100° C. for from about 5 to 10 minutes on a hot water bath with an aluminum foil capping for preventing a loss of aroma; and then allowed stand at room temperature to obtain a fermented tea drink. An autoclave treatment for 1 to 20 minutes at 120° C. may be employed instead of heating on a hot water bath. When the process of the present invention is to be scaled up to the level of industrial production, a crude filtration may be carried out by conventional methods followed by filtration using, for example, a Sharples centrifuge. In the case of producing a canned drink, the product is subjected to retort sterilization according to the requirements of the Food Sanitation Act. In the case of plastic bottles, tube sterilization or plate sterilization by the hot pack filling method may be employed. After the heat treatment, the liquid is subjected to a concentration step, e.g., vacuum concentration, spray drying, freeze drying to produce a concentrated liquid or powdered extract. The product can be provided as food products in various forms or as raw materials in various industries, such as food supplements, health care products, confectionary, pharmaceuticals, and food products.

The contents of all of the patents and reference documents explicitly cited in the application are hereby incorporated by reference in its entirety.

### EXAMPLES

The present invention is described in greater detail by the examples provided below, but the present invention is not limited by these examples. The contents of EC, ECG, EGC, EGCG, TF, TF3G, TF3′G, and TFDG were analyzed using an HPLC instrument (JASCO, PU-980, UV-970) and an ODS120A column (TOSO, 4.6 mm×250 mm). The HPLC conditions were as follows: solvent=acetonitrile: ethyl acetate: 0.05% H₃PO₄=21: 3: 76; flow rate=1.0 mL/min; temperature=25° C. Detection with 280 nm W. The measurements were calculated with respective calibration curves.

### Example 1

### Example of the Use of Five-Fold Water with Respect to the Fresh Tea Leaves and Milling for 8 Minutes

125 mL distilled water was added to 25.0 g benifuuki tea leaves harvested on 3 July and milled for 8 minutes using a household mixer. The mixture was filtered by suction filtration and the filtrate was transferred to a glass bottle, which was capped with aluminum foil. This was followed by autoclaving at 120° C. for 20 minutes and then standing at room temperature. Analysis by HPLC gave 63 mg TF (0.063%), 11 mg TF3G (0.011%), 4.5 mg TF3′G (0.0045%), 1.6 mg TFDG (0.0016%), 0 g EGCG (0%), 0 g ECG (0%), and 432 mg caffeine (0.43%) per 100 g fresh leaves.

### Example 2

### Example of the Use of Eight-Fold Water with Respect to the Fresh Tea Leaves and Milling for 8 Minutes

200 mL distilled water was added to 24.89 g benifuuki tea leaves harvested on 3 July and milled for 8 minutes using a household mixer. The mixture was filtered by suction filtration and the filtrate was transferred to a glass bottle, which was capped with aluminum foil. This was followed by autoclaving at 120° C. for 20 minutes and then standing at room temperature. Analysis by HPLC gave 127 mg TF (0.13%), 22.2 mg TF3G (0.022%), 8.1 mg TF3′G (0.008%), 3.7 mg TFDG (0.0037%), 0 g EGCG (0%), 0 g ECG (0%), and 558 mg caffeine (0.56%) per 100 g fresh leaves.

### Example 3

### Example of the Use of Eight-Fold Water with Respect to the Fresh Tea Leaves and Milling for 15 Minutes

200 mL distilled water was added to 24.89 g benifuuki tea leaves harvested on 3 July and milled for 15 minutes using a household mixer. The mixture was filtered by suction filtration and the filtrate was transferred to a glass bottle, which was capped with aluminum foil. This was followed by autoclaving at 120° C. for 20 minutes and then standing at room temperature. Analysis by HPLC gave 73.4 mg TF (0.073%), 14.1 mg TF3G (0.014%), 5.0 mg TF3′G (0.005%), 2.8 mg TFDG (0.0028%), 0 g EGCG (0%), 0 g ECG (0%), and 505 mg caffeine (0.51%) per 100 g fresh leaves.

### Example 4

### Example of the Use of Ten-Fold Water with Respect to the Fresh Tea Leaves and Shaking for 5 Minutes after Milling for 5 Minutes

100 mL distilled water was added to 10 g benifuuki second flush tea harvested on 23 July and this was milled for 5 minutes using a household mixer and then shaken (120 rpm) for 5 minutes at room temperature and subjected to suction filtration. The obtained filtrate was transferred to a glass bottle, which was capped with aluminum foil. This was followed by heating on a hot water bath at 100° C. for 10 minutes and then standing at room temperature. Analysis by HPLC gave 257 mg TF (0.26%), 92.7 mg TF3G (0.093%), 49.2 mg TF3′G (0.049%), 48.1 mg TFDG (0.048%), and 495 mg caffeine (0.50%) per 100 g fresh leaves.

### Example 5

### Example of the Use of Ten-Fold Water with Respect to the Fresh Tea Leaves and Shaking for 35 Minutes after Milling for 8 Minutes

200 mL distilled water was added to 19.13 g benifuuki second flush tea harvested on 23 July and milled for 8 minutes using a household mixer and then shaken (120 rpm) for 35 minutes at room temperature and subjected to suction filtration. The obtained filtrate was transferred to a glass bottle, which was capped with aluminum foil. This was followed by heating on a hot water bath at 100° C. for 10 minutes and then standing at room temperature. Analysis by HPLC gave 236 mg TF (0.24%), 62.7 mg TF3G (0.063%), 26 mg TF3′G (0.026%), 23.5 mg TFDG (0.024%), and 590 mg caffeine (0.59%) per 100 g fresh leaves.

### Example 6

### Example of the Use of Eight-Fold Water with Respect to the Fresh Tea Leaves and Shaking for 30 Minutes after Milling for 3 Minutes

218 mL distilled water was added to 26.68 g yabukita tea leaves harvested on 15 June and milled for 3 minutes using a household mixer and then shaken for 30 minutes at room temperature and subjected to suction filtration. The obtained filtrate was transferred to a glass bottle, filtered by suction filtration. The obtained filtrate was transferred to a glass bottle, sodium ascorbate was added, and the glass bottle was capped with aluminum foil. This was followed by heating on a hot water bath at 100° C. for 10 minutes and then standing at room temperature. Analysis by HPLC gave 176 mg TF (0.18%), 106 mg TF3G (0.11%), 74.0 mg TF3′G (0.074%), 106 mg TFDG (0.11%), 200 mg caffeine (0.20%), 0 g EGCG (0%), and 0 mg ECG (0%) per 100 g fresh leaves.

### Example 7

### Scale Up Example: Example of the Use of Eight-Fold Water with Respect to Frozen Fresh Tea Leaves and Shaking for 40 Minutes After Milling for 3 Minutes

306 g yabukita tea leaves harvested on 15 June were packed in an aluminum vacuum pack and were frozen and stored at −78° C. After 1 week, 4 L water was added to 76.5 g of the tea leaves that had been stored frozen and milled for 3 minute in an industrial mixer (high speed). The mixture was transferred to a 30-L stainless steel tank. The entire quantity of tea leaves (306 g) was milled by repeating this process for 4 times, and 9 L water was added to bring the total quantity of water to 25 L. The mixture was shaken for 40 minutes. After crude filtration, Na ascorbate was added and filtered, and then subjected to retort sterilization. Analysis by HPLC gave 1.9 g TF (0.19%), 1.2 g TF3G (0.12%), 800.0 mg TF3′G (0.08%), 1.1 g TFDG (0.11%), 2 g caffeine (0.20%), 0 g EGCG (0%), and 0 mg ECG (0%) per 1 kg tea leaves.

### Example 8

### Example of a Freeze-Dried Article Obtained by Using Ten-Fold Water with Respect to the Fresh Tea Leaves, Milling for 5 Minutes, and then Shaking for 5 Minutes

100 mL distilled water was added to 10 g benifuuki second flush tea harvested on 23 July and milled for 5 minutes using a household mixer and then shaken (120 rpm) for 5 minutes at room temperature and subjected to suction filtration. The obtained filtrate was transferred to a glass bottle, which was capped with aluminum foil. This was followed by heating on a hot water bath at 100° C. for 10 minutes and then freeze drying to obtain a product of 1.5 g. Analysis by HPLC gave 23 mg TF (1.5%), 8 mg TF3G (0.53%), 3 mg TF3′G (0.2%), 5 mg TFDG (0.33%), and 45 mg caffeine (3.0%) per 1.5 g product.

### Example 9

300 mL water was added to 20.5 g stems of benifuuki harvested on 15 July and milled for 3 minutes using a household mixer, transferred to a 100-mL Erlenmeyer flask, and then shaken for 30 minutes. After crude filtration, Na ascorbate was added and filtered, and then subjected to retort sterilization. 30 mg TF (0.03%), 10 mg TF3G (0.01%), 7 mg TF3′G (0.007%), 5 mg TFDG (0.005%), and 96 mg caffeine (0.1%) were obtained per 100 g fresh stems.

### Comparative Example 1

### Example of Milling in Air, Addition of 3.8-Fold Water, and Shaking for 1 Hour

8.55 g benifuuki tea leaves harvested on 23 July were milled with a household mixer followed by the addition of 32.7 mL distilled water and stirring by shaking for 1 hour at room temperature. The mixture was filtered under reduced pressure and the filtrate was transferred to a glass bottle, which was capped with aluminum foil. This was heated at 100° C. for 10 minutes and then allowed to stand at room temperature. Analysis by HPLC gave 98 mg TF (0.098%), 29 mg TF3G (0.029%), 10 mg TF3′G (0.010%), 3 mg TFDG (0.003%), 200 mg EGCG (0.2%), 0 mg ECG (0%) and 220 mg caffeine (0.22%) per 100 g fresh leaves.

### Comparative Example 2

### Example of Milling in Air, Addition of Ten-Fold Water, and Shaking for 1 Hour

11.86 g yabukita tea leaves harvested on 18 July were milled with a mixer followed by the addition of 118 mL distilled water and shaking for 60 minutes at room temperature. The mixture was filtered by suction filtration and the filtrate was transferred to a glass bottle, which was capped with aluminum foil. This was heated on a hot water bath at 100° C. for 10 minutes and then allowed to stand at room temperature. Analysis by HPLC gave 108 mg TF (0.11%), 15.2 mg TF3G (0.015%), 21 mg TF3′G (0.021%), 5.8 mg TFDG (0.006%), 176 mg caffeine (0.18%) 1.94 g EGCG (1.9%), and 56.8 mg ECG (0.057%) per 100 g fresh leaves.

The tea drinks obtained in the examples and comparative examples were evaluated by 5 panelists for aroma, water color, body, sweetness, and bitterness and astringency.

### Example 1

aroma: sweet aroma

water color: dark orange color

body: appropriate

bitterness and astringency: a somewhat bitter and astringent taste is present

sweetness: a slight sweetness is perceived

Comprehensive evaluation: while a faint sweet aroma is perceived, when held in the mouth, there is a slight residual bitter and astringent taste. There is a sweet perception to some degree, and a soothing effect can be expected.

### Example 2

aroma: sweet aroma

water color: dark orange color

body: appropriate

bitterness and astringency: a somewhat bitter and astringent taste is present

sweetness: sweetness is perceived

Comprehensive evaluation: while a very sweet aroma is perceived, when held in the mouth, there is a slight residual bitter and astringent taste. There is a sweet perception, and a soothing effect can be expected.

### Example 3

aroma: sweet aroma

water color: dark orange color

body: appropriate

bitterness and astringency: very weak

sweetness: sweetness is perceived

Comprehensive evaluation: while a very sweet aroma is perceived, when held in the mouth, the bitter and astringent taste is very weak; mild with a sweet perception; a soothing effect can be expected; very good balance as a whole.

### Example 4

aroma: the sweet aroma of tea with milk or a green tea-milk

water color: dark orange color

body: appropriate

bitterness and astringency: very weak

sweetness: sweetness similar to tea with milk or a green tea-milk

Comprehensive evaluation: while the sweet aroma of tea with milk or a green tea-milk is perceived, when held in the mouth, the bitter and astringent taste is very weak; the rich sweetness of tea with milk or a green tea-milk is perceived; a soothing effect can be expected; very good balance as a whole.

### Example 5

aroma: the sweet aroma of tea with milk or a green tea-milk

water color: dark orange color

body: appropriate

bitterness and astringency: very weak

sweetness: sweetness similar to tea with milk or a green tea-milk

Comprehensive evaluation: while the sweet aroma of tea with milk or a green tea-milk is perceived, when held in the mouth, the bitter and astringent taste is very weak; the rich sweetness of tea with milk or a green tea-milk is perceived; a soothing effect can be expected; very good balance as a whole.

### Example 6

aroma: aroma sensed as sweetness

water color: dark orange color

body: appropriate

bitterness and astringency: very weak

sweetness: appropriate sweetness

Comprehensive evaluation: while a soothing sensation is experienced due to the sweet aroma, when held in the mouth, the bitter and astringent taste is very weak; there is a perception of body and sweetness; a soothing effect can be expected; very good balance as a whole.

### Example 7

aroma: aroma sensed as sweetness

water color: dark orange color

body: appropriate

bitterness and astringency: very weak

sweetness: appropriate sweetness

Comprehensive evaluation: while a soothing sensation is experienced due to the sweet aroma, when held in the mouth, the bitter and astringent taste is very weak; there is a perception of body and sweetness; a soothing effect can be expected; very good balance as a whole.

### Example 9

aroma: aroma sensed as sweetness

water color: dark orange color

body: appropriate

bitterness and astringency: very weak

sweetness: appropriate sweetness

Comprehensive evaluation: while a soothing sensation is experienced due to the sweet aroma, when held in the mouth, the bitter and astringent taste is very weak; there is a perception of body and sweetness; a soothing effect can be expected; very good balance as a whole.

### Comparative Example 1

aroma: weak aroma

water color: blackish red, lack of transparency

body: appropriate

bitterness and astringency: bitterness is perceived

sweetness: weak sweetness

Comprehensive evaluation: weak aroma; when held in the mouth, a bitter and astringent taste is perceived, almost no sense of sweetness.

### Comparative Example 2

aroma: weak aroma

water color: dark orange color

body: appropriate

bitterness and astringency: bitterness is detected

sweetness: weak sweetness

Comprehensive evaluation: weak aroma; when held in the mouth, bitterness and astringency are detected, while almost no sweetness is perceived.

### Example 10

Yabukita tea leaves harvested on 7 October (fourth flush tea) were allowed to stand for 4 days at room temperature; 140 mL distilled water was then added to 14.76 g of the tea leaves and milled for 1 minute using a household mixer and then shaken for 37 minutes (120 rpm) at room temperature. 150 mg sodium ascorbate was then added. The mixture was filtered by suction filtration and the filtrate was transferred to a glass bottle, which was capped with aluminum foil. This was followed by heating on a hot water bath at 100° C. for 10 minutes and then standing at room temperature. HPLC analysis gave 132.4 mg TF (0.13%), 46.0 mg TF3G (0.046%), 33 mg TF3′G (0.033%), 24 mg TFDG (0.024%), and 261 mg caffeine (0.26%) per 100 g fresh leaves.

The obtained tea drink was evaluated by 5 panelists for aroma, water color, body, sweetness, and bitterness and astringency.

aroma: the aroma is perceived as an agreeable sweetness resembling herbal tea; the aroma is perceived as soothing

water color: dark orange color

body: appropriate

bitterness and astringency: very weak

sweetness: appropriate sweetness

Comprehensive evaluation: while a soothing sensation is experienced due to the fragrant aroma, when held in the mouth, the bitter and astringent taste is very weak; there is a perception of body and sweetness; a soothing effect can be expected; very good balance as a whole. In comparison to the creamy taste of second flush tea, fourth flush tea has a thin body and on the whole has a clean finish.

TABLE 1

| | fresh | weight | water | | TF | TF | TF3′G | TFDG | EGCG | ECG | Caffeine |
|---|---|---|---|---|---|---|---|---|---|---|---|
| No | leaf | (g) | (mL) | method | (%) | 3G(%) | (%) | (%) | (%) | (%) | (%) |
| Example | benifuuki | 25.0 | 125 | mixer 8 min | 0.063 | 0.011 | 0.0045 | 0.0016 | 0 | 0 | 0.43 |
| 1 | | | | autoclave | | | | | | | |
| Example | benifuuki | 24.89 | 200 | mixer 8 min | 0.13 | 0.022 | 0.008 | 0.0037 | 0 | 0 | 0.56 |
| 2 | | | | autoclave | | | | | | | |
| Example | benifuuki | 24.89 | 200 | mixer 15 min | 0.073 | 0.014 | 0.005 | 0.0028 | 0 | 0 | 0.51 |
| 3 | | | | autoclave | | | | | | | |
| Example | benifuuki | 10 | 100 | mixer 5 min | 0.26 | 0.093 | 0.049 | 0.048 | 0 | 0 | 0.50 |
| 4 | | | | shaking 5 min | | | | | | | |
| | | | | 100° C., 10 min | | | | | | | |
| Example | benifuuki | 19.13 | 200 | mixer 8 min | 0.24 | 0.063 | 0.026 | 0.024 | 0 | 0 | 0.59 |
| 5 | | | | shaking 35 min | | | | | | | |
| | | | | 100° C., 10 min | | | | | | | |
| Example | yabukita | 26.68 | 218 | mixer 3 min | 0.18 | 0.11 | 0.074 | 0.11 | 0 | 0 | 0.20 |
| 6 | | | | shaking 30 min | | | | | | | |
| | | | | 100° C., 10 min | | | | | | | |
| Example | yabukita | 306 | 25 L | mixer 3 min | 0.19 | 0.12 | 0.08 | 0.11 | 0 | 0 | 0.20 |
| 7 | | | | shaking 40 min | | | | | | | |
| | | | | retort | | | | | | | |
| | | | | sterilization | | | | | | | |
| Example | benifuuki | 10 | 100 | mixer 5 min | 1.5 | 0.53 | 0.2 | 0.33 | 0 | 0 | 3.0 |
| 8 | | | | shaking 5 min | | | | | | | |
| | | | | 100° C., 10 min | | | | | | | |
| | | | | freeze drying | | | | | | | |

TABLE 2

| | fresh | weight | water | | TF | TF | TF3′G | TFDG | EGCG | ECG | Caffeine |
|---|---|---|---|---|---|---|---|---|---|---|---|
| No | leaf | (g) | (mL) | method | (%) | 3G(%) | (%) | (%) | (%) | (%) | (%) |
| Example | benifuuki | 20.5 | 300 | mixer 3 min | 0.03 | 0.01 | 0.007 | 0.005 | 0 | 0 | 0.10 |
| 9 | (stems) | | | shaking 30 min | | | | | | | |
| | | | | retort | | | | | | | |
| | | | | sterilization | | | | | | | |
| Example | yabukita | 14.76 | 140 | mixer 1 min | 0.13 | 0.046 | 0.033 | 0.024 | 0 | 0 | 0.26 |
| 10 | | | | shaking 37 min | | | | | | | |
| | | | | 100° C., 10 min | | | | | | | |
| Comparative | benifuuki | 8.55 | 32.7 | milling in air | 0.098 | 0.029 | 0.010 | 0.003 | 0.20 | 0 | 0.22 |
| Example 1 | | | | shaking 60 min | | | | | | | |
| | | | | 100° C., 10 min | | | | | | | |
| Comparative | yabukita | 11.86 | 118 | milling in air | 0.11 | 0.015 | 0.021 | 0.006 | 1.9 | 0.057 | 0.18 |
| Example 2 | | | | shaking 60 min | | | | | | | |
| | | | | 100° C., 10 min | | | | | | | |

1. A process for preparing a fermented tea drink that substantially free of epigallocatechin gallate and epicatechin gallate, comprising the steps of:
adding water to fresh tea leaves and milling the mixture; removing a solid fraction from the mixture; and heating the liquid, or
adding water to fresh tea leaves and milling the mixture; incubating the mixture with shaking for 1 to 40 minutes; removing a solid fraction from the mixture; and heating the liquid;
to obtain the fermented tea drink.

2. A process for preparing a fermented tea concentrate that substantially free of epigallocatechin gallate and epicatechin gallate, comprising the steps of:
adding water to fresh tea leaves and milling the mixture; removing a solid fraction from the mixture; heating the liquid; and concentrating the liquid; or
adding water to fresh tea leaves and milling the mixture; incubating the mixture with shaking for 1 to 40 minutes; removing a solid fraction from the mixture; and heating the liquid; and concentrating the liquid;
to obtain the a fermented tea concentrate.

3. The process according to claim 1, wherein the shaking step is carried out for 5 minutes to 40 minutes.

4. The process according to claim 1, wherein the milling step is carried out for 1 second to 20 minutes.

5. The process according to claim 1, wherein the incubation step is carried out in the presence of at least five-fold (w/w) water with reference to the fresh tea leaves.

6. The process according to claim 5, wherein the incubation step is carried out in the presence of at least seven-fold (w/w) water with reference to the fresh tea leaves.

7. The process according to claim 1, wherein stems of tea leaves are used as the fresh tea leaves.

8. A fermented tea drink that substantially free of epigallocatechin gallate and epicatechin gallate, obtained by a process comprising the steps of:
adding water to fresh tea leaves and milling the mixture; removing a solid fraction from the mixture; and heating the liquid, or
adding water to fresh tea leaves and milling the mixture; incubating the mixture with shaking for 1 to 40 minutes; removing a solid fraction from the mixture; and heating the liquid.

9. A fermented tea concentrate that substantially free of epigallocatechin gallate and epicatechin gallate, obtained by a process comprising the steps of:
adding water to fresh tea leaves and milling the mixture; removing a solid fraction from the mixture; heating the liquid; and concentrating the liquid; or
adding water to fresh tea leaves and milling the mixture; incubating the mixture with shaking for 1 to 40 minutes; removing a solid fraction from the mixture; and heating the liquid; and concentrating the liquid.

10. The process according to claim 2, wherein the shaking step is carried out for 5 minutes to 40 minutes.

11. The process according to claim 2, wherein the milling step is carried out for 1 second to 20 minutes.

12. The process according to claim 2, wherein the incubation step is carried out in the presence of at least five-fold (w/w) water with reference to the fresh tea leaves.

13. The process according to claim 12, wherein the incubation step is carried out in the presence of at least seven-fold (w/w) water with reference to the fresh tea leaves.

14. The process according to claim 2, wherein stems of tea leaves are used as the fresh tea leaves.
